(19) United States
(12) Patent Application Publication
(10) Pub. No.: US 2010/0138348 A1
(43) Pub. Date: Jun. 3, 2010

(54) PROVIDING RESOURCE-RELATED INFORMATION USING A STANDARDIZED FORMAT

(75) Inventor: Michaeljon Miller, Bellevue, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/483,248

(22) Filed: Jun. 12, 2009

(51) Int. Cl. G06Q 10/00; G06F 17/00; G06Q 50/00; H04L 9/00; G06Q 30/00

(52) U.S. Cl. 705/63; 705/30; 705/34; 707/E17.045

(57) ABSTRACT

A standardized format is described for representing resource-related information associated with different utility entities. The standardized format can be expressed using three files. A usage file expresses the consumption of resources, an invoice file expresses invoices associated with the consumption of resources, and a rate file expresses different rates which have a bearing on the cost of the resources at different locations. The files are governed by three respective schemas. Functionality is also described which enables a resource management facilitator to interact with the different utility entities and receive the resource-related information therefrom. In one illustrative approach, a utility entity sends a message which indicates that one or more files are available for downloading. The resource management facilitator then retrieves the files and processes the files in an appropriate manner, as specified by information within the message.

### BACKGROUND

There is a growing demand for functionality which will enable the customers of utility companies to more efficiently manage their consumption of resources (such as electricity, natural gas, water, etc.). However, customers face a number of challenges in achieving this goal. First, utility companies historically have been reluctant to provide customers with detailed information regarding their consumption of resources (referred to as resource-related information herein). As such, a customer may have difficulty obtaining resource-related information that is sufficiently timely and sufficiently rich to provide effective analysis. Second, utility companies typically maintain resource-related information using proprietary native formats. As such, a customer may have difficulty interpreting and utilizing the resource-related information from different companies. Third, utility companies typically collect enormous amounts of resource-related information. Even if such information were made available, there are daunting technical challenges in storing this information and for delivering this information to customers in an efficient manner. The above-noted difficulties also confront developers who wish to provide tools and techniques to process resource-related information in an effective manner.

### SUMMARY

According to one illustrative implementation, a standardized format is described for expressing resource-related information. The standardized format provides a consistent way of representing the resource-related information associated with different utility entities. Further, the standardized format is energy-independent, flexible, and extensible. The use of a standardized format facilitates the interpretation of resource-related information by customers and the development of efficient tools which process the resource-related information.

According to one illustrative aspect, the standardized format can be expressed in at least three different files. Each file is governed by a respective schema. A usage file expresses the consumption of resources. An invoice file expresses invoice information pertaining to the consumption of resources. And a rate file expresses rate information that has a bearing on the cost of resources for different locations.

According to another illustrative aspect, functionality is described for gathering the resource-information and packaging the resource-related information into the above-described three files. The functionality then publishes one or more of the files at a secure location that is accessible to a receiving entity. In one representative approach, the functionality then sends the receiving entity a message that indicates that the files are available. Such a message can identify the location at which the files have been stored and the security provisions that have been applied to the files. The receiving entity can then access and process the files based on the information imparted by the message. This approach is one option; the functionality can provide the files to the receiving entity using other protocols and transfer mechanisms.

According to one illustrative aspect, the receiving entity corresponds to a resource management facilitator. The resource management facilitator receives resource-related information from one or more utility entities. Customers can interact with the resource management facilitator to gain access to the resource-related information. In this manner, the resource management facilitator acts as a clearinghouse for the standardized resource-related information.

According to one illustrative aspect, the utility entities and the resource management facilitator interact with each other using any communication mechanism, such as, but not limited to, web service functionality.

The above functionality can be manifested in various types of systems, components, methods, computer readable media, schemas, data structures, articles of manufacture, and so on.

This Summary is provided to introduce a selection of concepts in a simplified form; these concepts are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 shows an illustrative environment in which a resource management facilitator (“facilitator”) receives resource-related information in a standardized format from one or more utility entities; the facilitator then makes the resource-related information available to customers of the utility entities.

FIG. 2 shows utility processing functionality and facilitator processing functionality provided, respectively, by the utility entities and the facilitator of FIG. 1.

FIGS. 3 and 4 show a generalized overview of a conversation involving the exchange of messages between the utility entities and the facilitator of FIG. 1.

FIGS. 5 and 6 show conversations involving the exchange of testing-type messages between the utility entities and the facilitator.

FIGS. 7 and 8 show conversations involving the exchange of registration-type messages (or unregistration-type messages) between the utility entities and the facilitator.

FIG. 9 shows a conversation in which a utility entity notifies the facilitator of the availability of files to be downloaded.

FIG. 10 shows an illustrative procedure, implemented by a utility entity, for preparing resource-related information and notifying the facilitator of the availability of the resource-related information.

FIG. 11 shows an illustrative procedure, implemented by the facilitator, for receiving resource-related information from a utility entity and for processing the resource-related information.

FIG. 12 shows an overview of illustrative resource-related items within a usage file, governed by a usage schema.

FIG. 13 shows an example of a usage file which is based on the elements shown in FIG. 12.

FIG. 14 shows an overview of illustrative resource-related items within an invoice file, governed by an invoice schema.

FIGS. 15 and 16 show an example of an invoice file which is based on the elements shown in FIG. 14.

FIG. 17 shows an overview of illustrative resource-related items within a rate file, governed by a rate schema.

FIG. 18 shows an example of a rate file which is based on the elements shown in FIG. 17.

FIG. 19 shows illustrative processing functionality that can be used to implement any aspect of the features shown in the foregoing drawings.

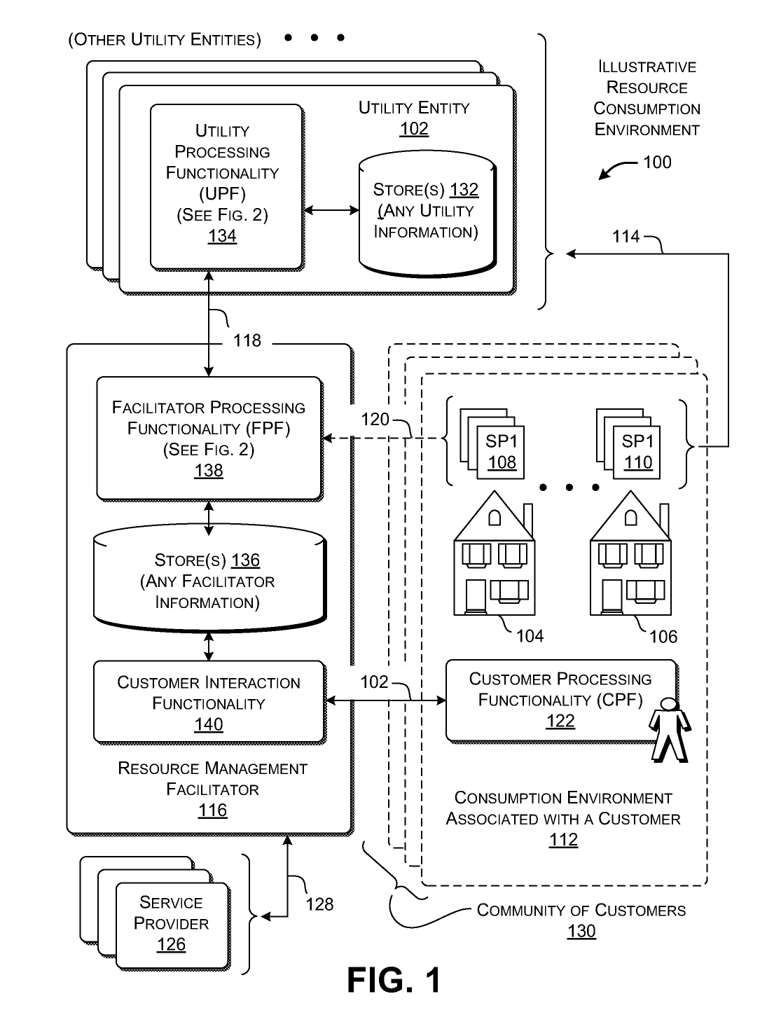

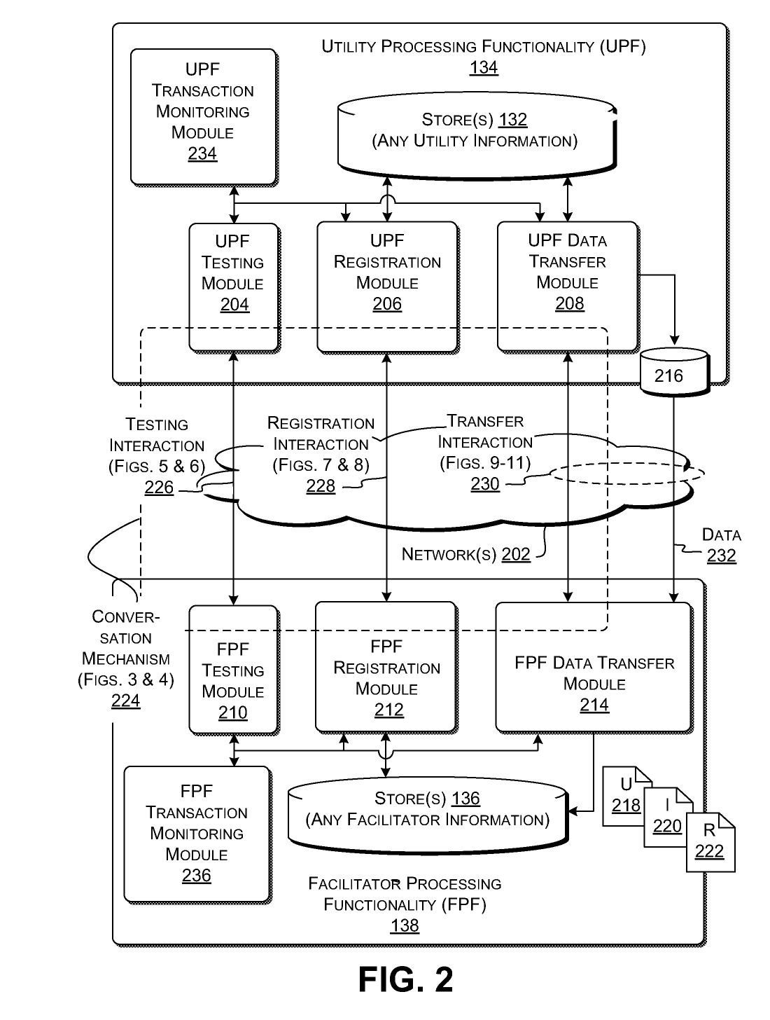

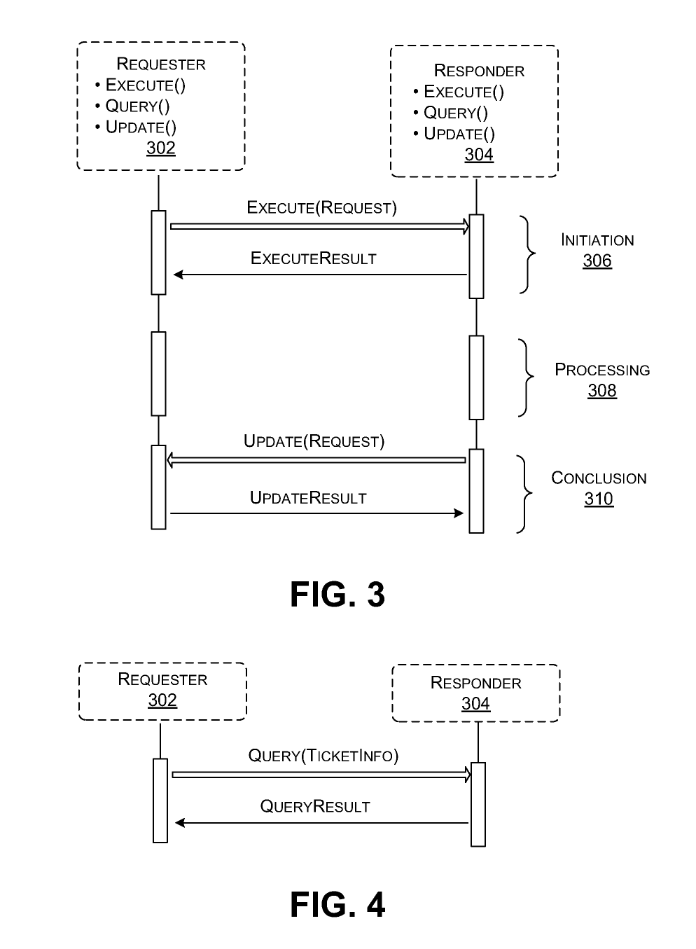

The same numbers are used throughout the disclosure and figures to reference like components and features. Series 100 numbers refer to features originally found in FIG. 1, series 200 numbers refer to features originally found in FIG. 2, series 300 numbers refer to features originally found in FIG. 3, and so on.

### DETAILED DESCRIPTION

This disclosure sets forth a standardized format for representing resource-related information. The disclosure also describes functionality for forming, publishing, receiving, and processing the resource-related information.

This disclosure is organized as follows. Section A describes illustrative systems which implement the functions summarized above. Section B describes illustrative signal diagrams and flowcharts which explain the operation of the systems of Section A. Section C describes illustrative files for expressing resource-related information in the standardized format. And section D describes illustrative processing functionality that can be used to implement any aspect of the features described in the preceding sections.

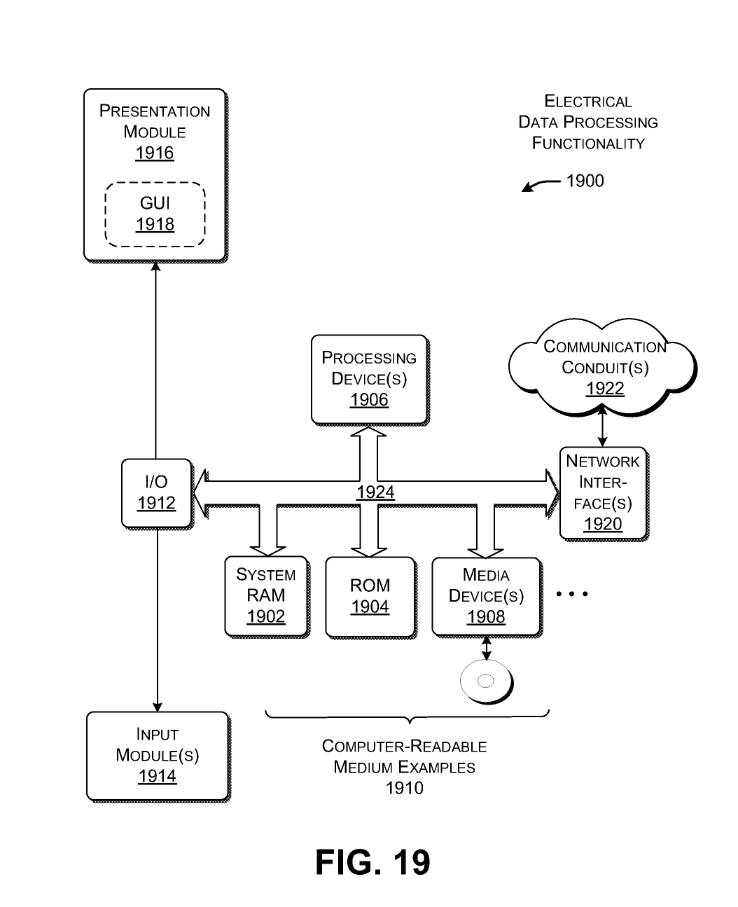

As a preliminary matter, some of the figures describe concepts in the context of one or more structural components, variously referred to as functionality, modules, features, elements, etc. The various components shown in the figures can be implemented in any manner, for example, by software, hardware (e.g., discrete logic components, etc.), firmware, and so on, or any combination of these implementations. In one case, the illustrated separation of various components in the figures into distinct units may reflect the use of corresponding distinct components in an actual implementation. Alternatively, or in addition, any single component illustrated in the figures may be implemented by plural actual components. Alternatively, or in addition, the depiction of any two or more separate components in the figures may reflect different functions performed by a single actual component. FIG. 19, to be discussed in turn, provides additional details regarding one illustrative implementation of the functions shown in the figures.

Other figures describe the concepts in flowchart form. In this form, certain operations are described as constituting distinct blocks performed in a certain order. Such implementations are illustrative and non-limiting. Certain blocks described herein can be grouped together and performed in a single operation, certain blocks can be broken apart into plural component blocks, and certain blocks can be performed in an order that differs from that which is illustrated herein (including a parallel manner of performing the blocks). The blocks shown in the flowcharts can be implemented by software, hardware (e.g., discrete logic components, etc.), firmware, manual processing, etc., or any combination of these implementations.

As to terminology, the phrase “configured to” encompasses any way that any kind of functionality can be constructed to perform an identified operation. The functionality can be configured to perform an operation using, for instance, software, hardware (e.g., discrete logic components, etc.), firmware etc., and/or any combination thereof.

The term “logic component” encompasses any functionality for performing a task. For instance, each operation illustrated in the flowcharts corresponds to a logic component for performing that operation. An operation can be performed using, for instance, software, hardware (e.g., discrete logic components, etc.), firmware, etc., and/or any combination thereof. When implemented by a computing system, a logic component represents an electrical component that is a physical part of the computing system, however implemented.

### A. Illustrative Systems

FIG. 1 shows an illustrative environment 100 in which resource-related information can be passed among different entities. As used herein, the term “resource-related information” encompasses any information which has a bearing on the consumption of resources. Different parts of the resource-related information are referred to as respective resource-related items. The term “resource” encompasses any tangible or intangible goods or services that can be provided to a customer and tracked on a specified basis (e.g., a per-unit basis). Without limitation, a resource may correspond to electricity, gas of any type, heating oil, water, and so on. Many of the examples presented herein pertain to the consumption of electricity and gas; but, the principles described herein are not limited to these types of consumable resources.

In FIG. 1, one or more utility entities provide resources to customers. The utility entities may correspond to different commercial providers of resources, such as one or more regional providers of electricity, one or more regional providers of natural gas, and so on. Alternatively, or in addition, the utility entities may encompass more localized providers of resources, such as homeowners who produce excess electricity for use by others. To facilitate discussion, the utility entities will be discussed in the context of an illustrative utility entity 102.

A customer (or resource consumer) refers to any individual or other entity (or group of entities) which consumes the resource provided by the utility entity 102. The customer may own or otherwise be associated with one or more resource-receiving units (104, 106) at which the resource is consumed, such as, without limitation, one or more building units of any type. For example, the customer may represent the owner of one or more building units that receive electricity from an electricity utility entity and/or gas from a gas utility entity. Each building unit can include one or more service points. For example, resource-receiving unit 104 can include one or more service points, including representative service point 108. Resource-receiving unit 106 can include one or more service points, including representative service point 110. A service point is associated with any kind of metering mechanism which measures the consumption of a resource within a resource-receiving unit of any type. In other words, a service point may correspond to a utility meter.

FIG. 1 refers to the facilities and functionality associated with a particular customer as a consumption environment 112. To facilitate discussion, the utility entity 102 is described as providing services to the single consumption environment 112 associated with a particular customer; in practice, the utility entity 102 will typically provide services to a large number of customers and associated consumption environments.

The utility entity 102 receives resource-related information from the service points (e.g., 108, 110) through a transport mechanism 114 in the form of electrical digital data. The resource-related information includes information that describes an amount of a resource that is consumed by the customer over an identified span of time. In one case, the transport mechanism 114 can correspond to one or more networks for electronically delivering the resource-related information to the utility entity 102. Such networks may comprise, or may include, one or more conventional backhaul networks, and/or one or more wireless networks, etc. Alternatively, or in addition, the utility entity 102 may collect the resource-related information using a manual technique. In this technique, employees of the utility entity 102 may physically visit the service points (108, 110) and record the consumption of resources that is indicated by those service points (108, 110), with or without the assistance of any known type of meter reading mechanism. The utility entity 102 can receive the resource-related information on any temporal basis. Typically, the utility entity 102 receives the resource-related information at periodic intervals.

A resource management facilitator 116 (referred to as a “facilitator” below for brevity) receives resource-related information from different utility entities, including utility entity 102. In doing so, the facilitator 116 acts as clearinghouse of information pertaining to the consumption of resources. The facilitator 116 can receive the resource-related information from the utility entity 102 via a coupling mechanism 118. Alternatively, or in addition, the facilitator can receive resource-related information directly from the service points (108, 110) via a coupling mechanism 120. Thus, in one implementation, the service points (108, 110) can supply the resource-related information to just the utility entity 102, which, in turn, passes the resource-related information to the facilitator 116. In another implementation, the service points (108, 110) can directly supply the resource-related information to just the facilitator 116. In another implementation, the service points (108, 110) can supply the resource-related information to both the utility entity 102 and to the facilitator 116.

In any event, the facilitator 116 asks any supplier of resource-related information to package the resource-related information into a predetermined format. In one implementation, for instance, the facilitator 116 asks the suppliers to express the resource-related information in three files. A resource usage file expresses the consumption of resources by one or more customers. An invoice file expresses the invoice information associated with the consumption of resources by one or more customers. And a rate file expresses rate information which has a bearing on the cost of the resources.

Each file expresses resource-related items using a data structure, as governed by a schema. Each schema identifies the acceptable types of resource-related items that can be included in a particular file. Each acceptable type is defined by a corresponding element, such an account element, a service point element, a usage element, and so on. The schema also identifies the acceptable attributes associated with each element (if, in fact, the element includes one or more attributes). The schema also identifies the acceptable values associated with each attribute. The schema also identifies the acceptable form associated with each element. The schema also specifies how resource-related items can be organized within a file. In summary, the schema identifies the format of individual resource-related items within a file as well as the data structure of the file as a whole, where the term “format” encompasses any characteristic of the resource-related items and/or the data structure as a whole. Section C presents examples of the ways in which the resource-related information can be expressed in a standardized format, as governed by one or more schemas.

A customer or other authorized entity can access the resource-related information from the facilitator 116 using customer processing functionality (CPF) 122. The CPF 122 represents any mechanism for receiving information via a coupling mechanism 124. In one case, the CPF 122 can correspond to any type of computing device, such as a workstation computer, a laptop computer, a personal digital assistant (PDA) device, a mobile telephone device, a set-top box device, a game console device, any kind of dedicated consumption monitoring and/or analysis device, and so on. In one case, the CPF 122 may provide viewing functionality which allows the customer to view resource-related information pertaining to his or her consumption of resources within the consumption environment 112. This viewing functionality can include one or more presentation tools which present the resource-related information in various ways, such as table formats, graph formats, and so on. In addition, or alternatively, the CPF 122 can include analysis functionality which performs any type of analysis on the resource-related information. To name merely one example, the analysis functionality can analyze the resource-related information in relation to characteristics of the resource-receiving units (104, 106). Based on this analysis, the analysis functionality can generate recommendations regarding how the customer can reduce his or her energy costs.

One or more service providers, such as representative service provider 126, may also interact with the facilitator 116 via coupling mechanism 128. In addition, or alternatively, the service providers can directly interact with the customer's CPF 122. The service providers provide any goods or services which have a bearing on the customer's consumption of resources. For example, one service provider may represent a company which sells energy-efficient windows and doors. Another service provider may represent a company which installs supplemental insulation to houses. In one implementation, if authorized by the customer, the facilitator 116 can analyze the resource-related information that describes the customer's use of resources. Based on this analysis, the facilitator 116 can then identify one or more service providers which can help the customer in reducing his or her resource consumption. Alternatively, or in addition, the service providers can independently perform the above-described type of analysis (if authorized by the customers).

The facilitator 116 and/or service providers can also provide services that are applicable to particular communities of customers, such as representative community 130. The facilitator 116 and/or service providers can identify a community based on any factor or combination of factors. In one case, the facilitator 116 can identify a community based on the geographic location of customers. Alternatively, or in addition, the facilitator 116 can identify a community based on the type of resource-receiving units associated with the customers (e.g., by grouping customers who live in similar types of houses, etc.). Alternatively, or in addition, the facilitator 116 can identify a community based on the goals defined by the customers. For example, the facilitator 116 can identify a group of customers who have expressed a heightened interest in energy conservation. The facilitator 116 can analyze the resource-related information that is associated with customers within a community, and then provide recommendations which are applicable to the community in general. In addition, or alternatively, the facilitator 116 can assess the general preferences and habits of customers within a community, and provide recommendations based thereon. For example, the facilitator 116 can allow customers to rank local service providers; the facilitator 116 can then expose those rankings to members of the community. The facilitator 116 can provide yet other types of services to any customer or group of customers. The above examples are representative, not exhaustive.

The facilitator 116 can take appropriate precautions to safeguard the privacy of information associated with customers. Moreover, the facilitator 116 can allow the customers to expressly opt in or opt out of its various services. Moreover, the facilitator 116 can allow customers to control their data, including the creation, deletion, and dissemination of the data.

In one implementation, the facilitator 116 can be implemented by a computer system that is accessible via a network. For example, the facilitator 116 can be implemented by one or more server-type computer devices, one or more data stores, and/or other data processing equipment. In this implementation, the coupling mechanisms 118, 120, 124, and 128 may represent network connections to the facilitator 116. The network which implements these network connections may represent a wide area network (such as the Internet), a local area network, a point-to-point coupling mechanism, or any combination thereof. The network can include any combination of hardwired links, wireless links, routers, gateways, name servers, and on. The network can be governed by any protocol or combination of protocols.

The following description provides additional information regarding the interaction between the utility entity 102 and the facilitator 116, as well as the schemas used to express the resource-related information. Before that more detailed description, it is instructive to consider the high-level role of the standardized resource-related information within the environment 100.

The standardized resource-related information provides a generalized approach for expressing resource-related information received from different utility entities (or other sources), regardless of the particularities of the native formats used by the different utility entities, and independent of the type of resource provided by the different utility entities. Further, the standardized resource-related information is designed to be flexible and extensible (e.g., scalable). Further, the standardized resource-related information is constructed so as to accommodate future changes in the native formats used by the utility entities, as well as changes in the manner in which the resource-related information is processed (e.g., by compressing it and encrypting it, etc.).

These characteristics may confer various benefits. For example, standardized resource-related information makes it easier to integrate the resource-related information provided by different utility entities. Further, the standardized resource-related information makes it easier for the customers to interpret this information. Further, the standardized resource-related information facilitates the processing of such information by the facilitator 116, CPF 122, service providers, and other entities. In other words, these processing components are not asked to provide specialized or ad hoc conversion functionality which takes account for the native formats used by different utility entities. The processing components also need not undergo frequent updating; this is because the resource-related information is designed to be relatively resilient to changes in the native formats used by different utility entities and changes in the way that the resource-related information is processed. In other words, the resource-related information is forward-looking, attempting to accommodate these future changes by virtue of its flexible schemas.

Finally, note that the standardized resource-related information is described for use in the illustrative environment 100 of FIG. 1. However, other environments can also make use of the standardized resource-related information. For example, in the following description, the utility entities are tasked with the responsibility of packaging the resource-related information into a standardized form defined by various schemas and then supplying the standardized resource-related information to the facilitator 116. In other environments, other entities can form and supply the standardized resource-related information.

Continuing with the explanation of FIG. 1, the utility entity 102 can include a computer system for performing its various services, including one or more computer devices, one or more data stores, and/or other data processing equipment. For example, the utility entity 102 may include one or more stores 132 (referred to in the singular below for simplicity). The store 132 can retain any resource-related information received from the various service points (108, 110) pertaining to the consumption of resources. The store 132 can also store other resource-related information, such as administrative information regarding the utility entity's 102 various customers, rates, etc. The utility entity 102 also includes utility processing functionality (UPF) 134 for collecting and operating on the resource-related information. The UPF 134 also includes functionality that allows it to interact with the facilitator 116.

The facilitator 116 includes one or more stores 136 (referred to in the singular below for simplicity). The store 136 can retain any resource-related information received from the utility entities or from other sources pertaining to the consumption of resources. The store 136 can also store any other information relating to resource consumption, such as the identities of customers who subscribe to its services, rates, etc. The facilitator 116 also includes facilitator processing functionality (FPF) 138 that allows it to interact with the UPF 134 of the utility entity 102. The FPF 138 also includes functionality which allows it to process the resource-related information received from the UPF 134. The facilitator 116 also includes customer interaction functionality 140 which allows the facilitator 116 to interact with the CPF 122 associated with a particular customer.

FIG. 2 shows additional illustrative details regarding the UPF 134 provided by the utility entity 102 and the FPF 138 provided by the facilitator 116, which interact with each via a coupling mechanism 118. In this figure, the coupling mechanism is represented by a network 202, such as a wide area network (e.g., the Internet).

The UPF 134 can include (or can be conceptualized to include) a collection of modules for performing different respective functions, such as a UPF testing module 204, a UPF registration module 206, and a UPF data transfer module 208. Likewise, the FPF 138 can include (or can be conceptualized to include) a collection of modules for performing different respective functions, such as an FPF testing module 210, an FPF registration module 212, and an FPF data transfer module 214. The testing modules (204, 210) perform the task of testing the availability of each other's respective services. The registration modules (206, 212) handle the task of registering the requests of customers to receive resource-related information from one or more utility entities via the facilitator 116, and for later cancelling those requests. The process of registering and unregistering the customers' requests is referred to below in shorthand fashion as the registration of customers and the un-registration of customers, respectively. Although not shown, the UPF 134 can also include a module for receiving resource-related information from a plurality of service points or other sources.

The data transfer modules (208, 214) perform various tasks associated with the transfer of resource-related information from the utility entity 102 to the facilitator 116. For example, the UPF data transfer module 208 performs the task of packaging the resource-related items into the standardized format expected by the facilitator 116, producing one or more files. The UPF data transfer module 208 can then compress and encrypt the files, and then publish the files to an identified location 216 that is accessible to the facilitator 116. The UPF data transfer module 208 and the FPF data transfer module 214 then interact with each other to transfer the files. The files can include a resource usage file 218, an invoice file 220, and a rate file 222.

The UPF 134 and the FPF 138 can use any conversation mechanism for exchanging information with each other, such as, without limitation, web services functionality. FIG. 2 generically represents such functionality as conversation mechanism 224. FIGS. 3 and 4 in Section B provide general information regarding one manner of operation of the conversation mechanism 224.

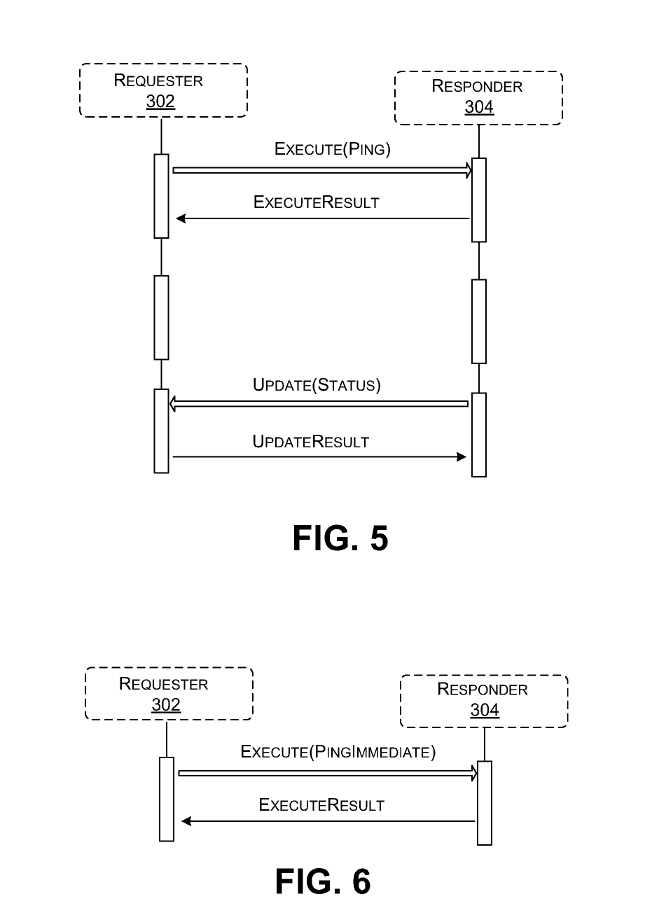

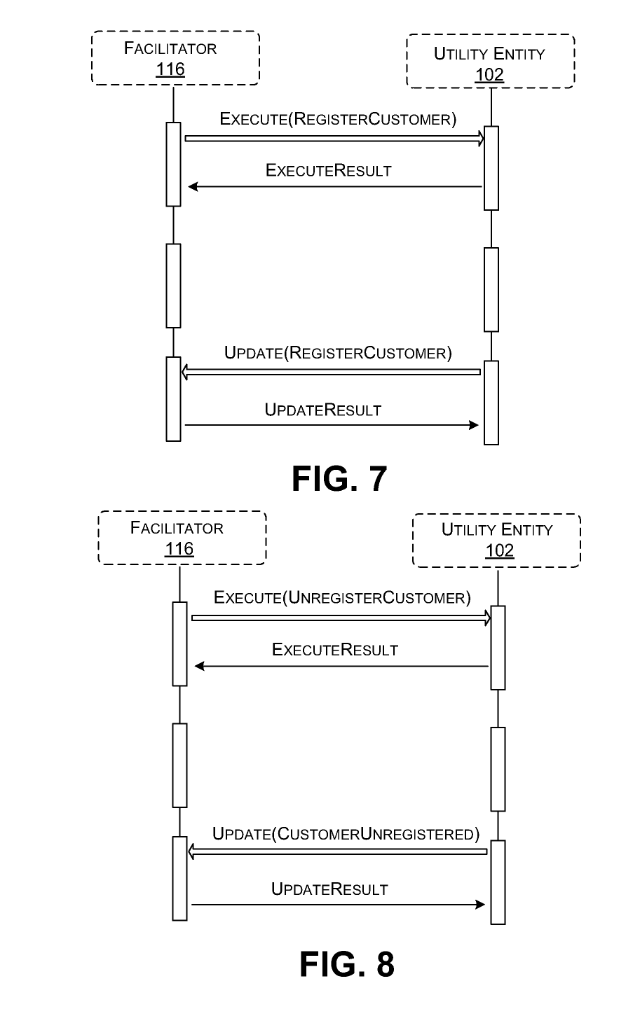

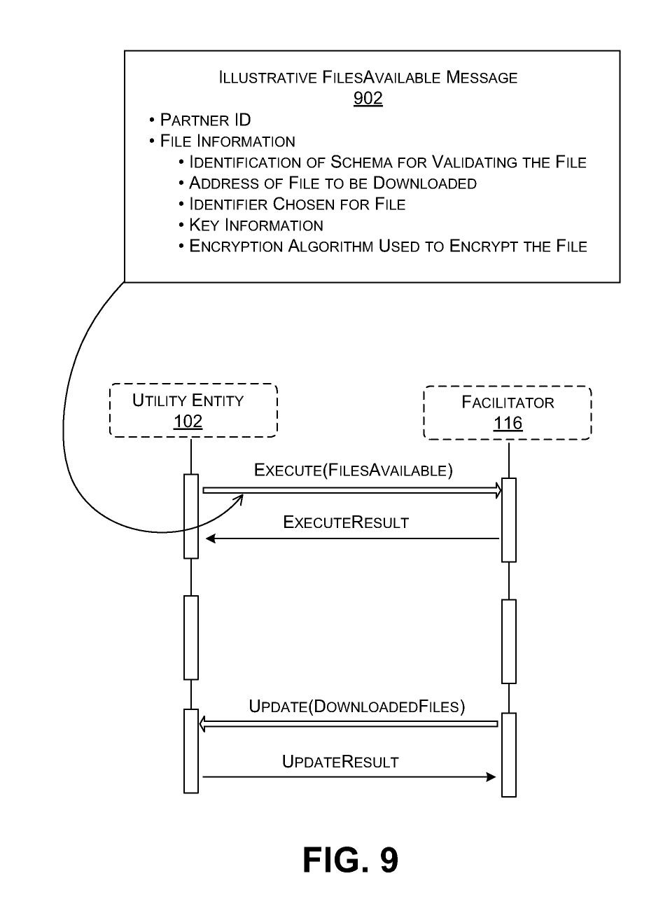

The conversation mechanism 224 can implement an exchange of electrical digital data messages between the UPF testing module 204 and the FPF testing module 210, as represented by interaction 226. FIGS. 5 and 6 of Section B provide additional information regarding this interaction 226. The conversation mechanism 224 can also implement an exchange of messages between the UPF registration module 206 and the FPF registration module 212, as represented by interaction 228. FIGS. 7 and 8 of Section B provide additional information regarding this interaction 228. The conversation mechanism 224 can also implement an exchange of messages between the UPF data transfer module 208 and the FPF data transfer module 214, as represented by interaction 230. FIGS. 9-11 of Section B provide additional information regarding this interaction 230. FIG. 2 represents the actual exchange of resource-related information as transfer path 232.

Finally, the UPF 134 can provide a UPF transaction monitoring module 234, while the FPF 138 can provide an FPF transaction monitoring module 236. The transaction monitor modules (234, 236) keep track of the exchange of messages between the UPF 134 and FPF 138. In one case, the FPF transaction monitoring module 236 assigns a ticket identifier (e.g., any unique identifier) to conversations that the facilitator 116 initiates or that the utility entity 102 initiates. The UPF transaction monitoring module 234 can monitor the conversations by keeping track of these ticket identifiers.

### B. Illustrative Manner of Operation

As noted in the previous section, the utility entity 102 and the facilitator 116 can use any conversation mechanism 224 to conduct a conversation. Without limitation, one such mechanism is a web services mechanism. Other technologies that can be used include CORBA, DCOM, RMI, etc. FIGS. 3 and 4 present an overview of the conversation mechanism 224, while FIGS. 5-9 describe how this mechanism can be used for performing tests, customer registration (including unregistering customers), and data transfer.

Starting with FIG. 3, this figure shows a general conversation that takes place between a requester 302 and a responder 304. The requester 302 is the entity that initiates the conversation and the responder 304 is the entity which responds to the requester 302. In some cases, the requester 302 is the utility entity 102; in other cases, it is the facilitator 116. Likewise, in some cases the responder is the utility entity 102; in other cases it is the facilitator 116.

Both the requester 302 and the responder 304 implement at least three different methods: Execute, Query, and Update. Each of these methods receives a particular input message and provides an output result. An entity calls the Execute method when it wants to initiate a conversation. An entity calls the Query method during development or other non-typical circumstance to investigate some aspect of the conversation mechanism 224. Any entity calls the Update method when it wants to notify the other entity of the status of conversation that the other entity initiated.

A conversation is described by the type of electrical digital data message with which it was initiated and an identifier (e.g., a ticket identifier) that it is assigned to the conversation by the FPF 138. In the case of a web services mechanism, a message corresponds to a block of information expressed in a markup language, e.g., the extensible markup language (XML).

The operations in a conversation can be characterized as an initiation phase 306, a processing phase 308, and a conclusion phase 310. In the initiation phase 306, the requester 302 communicates a task to be performed by the responder 304. In the processing phase 308, the responder 304 carries out this task. In the conclusion phase 310, the responder 304 notifies the requester 302 of the results of its processing.

More specifically, in the initiation phase 306, the requester 302 calls the responder's 304 Execute method, passing in a message whose type denotes the nature of the conversation. For example, if the requester 302 is the facilitator 116, then the message direct the responder 304 (e.g., the utility entity 102) to register a customer (as will be described with reference to FIG. 7). If the utility entity 102 is the requester 302, the message may notify the responder 304 (e.g., the facilitator 116) that files are available to be downloaded (as will be described with reference to FIG. 9). In either case, the requester 302 is asking the responder 304 to carry out a task that may not be instantaneously completed and also may not be completed in set timeframe. In this sense, the conversation is asynchronous.

In response to invocation of the Execute method, the responder 304 provides an acknowledgement that the message was received. Regardless of what actor initiated the conversation, the facilitator 116 assigns an identifier (such as a GUID-type ticket identifier) to each conversation. That is, if the facilitator 116 is the requester 302, the ticket identifier is passed in the initial call to the Execute method. If the facilitator 116 is the responder 304, the ticket identifier is passed in the immediate result to the initial call to the Execute method.

While the responder 304 is processing the conversation in the processing phase 308, at any time, either of two optional web service calls may occur. First, as shown in FIG. 4, the requester 302 may call the responder's 304 Query method, passing in a TicketInfo message containing the ticket identifier for the conversation (which was previously assigned by the facilitator 116). The responder's 304 immediate result contains updated status information. Second, the responder 304 may independently call the requester's 302 Update method, passing in a Status message informing the requester 302 of a change in the status of the conversation. These two web service calls are optional, meaning that the processing phase 308 can complete without either being performed.

In the conclusion phase 310, the responder 304 calls the requester's 302 Update method, passing in a Status message; this message specifies that the conversation has been completed. The status of a conversation can take on various values; in one merely illustrative case, the possible values include “TicketUnknown,” “Completed,” “Pending,” “Processing,” or “Failed.”

FIGS. 5 and 6 show test-related interaction between the requester 302 and responder 304. A requester 302 may invoke this interaction to verify the status of the responder 304. In one case, this interaction is invoked by the testing modules (204, 210) during a development stage, e.g., when a utility entity 102 is first establishing a relationship with the facilitator 116. This interaction can also be invoked later if some question arises regarding the status of the utility entity 102 or the facilitator 116.

In FIG. 5, the requester 302, e.g., the utility entity 102, can check connectivity and verify the status of the facilitator 116 by calling the facilitator's 116 Execute web service method, passing a Ping message as input. Alternatively, the requester 302 may correspond to the facilitator 116, which sends the Ping message to the utility entity 102 to check connectivity and verify the status of the utility entity's 102 service. The Ping message itself provides an identifier (e.g., PartnerId) associated with the utility entity 102. The Ping message also includes a ticket identifier assigned to the conversation by the facilitator 116.

Receipt of the Ping message initiates a web service conversation involving calls in both directions. The responder 304 first replies to indicate that it is available. Thereafter, the responder 304 calls the requester's 302 Update web service method to verify that the responder 304 is also capable of calling into the requester's 302 web service methods.

In FIG. 6, the requester 302 calls the responder's 304 Execute method passing the message PingImmediate as input. This invokes an interaction that constitutes a single web service call rather than a web service conversation involving multiple calls in both directions. In response to this message, the responder 304 sends a result which verifies connectivity to the system. The PingImmediate message includes the same attributes as the Ping message.

FIG. 7 shows a conversation whereby the facilitator 116 can register a customer, which enables the customer to interact with the facilitator 116. To perform this function, the facilitator 116 initiates a web service conversation by calling into the utility entity's 102 Execute web service method and passing in a RegisterCustomer message as input.

In one representative and non-limiting case, the RegisterCustomer message includes an identifier (e.g., PartnerId) which identifies the utility entity 102 and a ticket identifier which identifies the conversation that it is initiating. The message can also identify the type of service for which the customer is registering, such as “Electric” or “Gas.” The message can also include a series of answers provided by the customer. That is, the utility entity 102 can collect, in advance, the customer's answers to the questions. The facilitator 116 collects the same answers for the purpose of verifying to the utility entity 102 that it is authorized to provide resource-related information to the person claiming to be a customer of the utility entity 102. The message can also identify the language in which the answers are written. The message can also provide identifiers assigned to the answers.

When the utility entity 102 receives the RegisterCustomer message as input, it verifies whether the message originated from one of its customers by comparing the answers in the message with the answers that the customer previously provided. If the customer is verified, the utility entity 102 generates an identifier (e.g., CustomerId) for use in subsequently identifying the customer. In one case, the CustomerId that the utility entity 102 assigns to the customer is different from the identifier which it internally uses to represent the customer for other native purposes. The utility entity 102 can then begin sending resource-related information for this customer to the facilitator 116.

Upon completing the above operations, the utility entity 102 calls the facilitator's 116 Update web service method, passing a properly populated CustomerRegistered message as input. The CustomerRegistered message informs the facilitator of the outcome of its processing of the RegisterCustomer message. According to one illustrative and non-limiting case, the CustomerRegistered message can include an attribute which identifies the utility entity 102 (e.g., PartnerId) and a ticket identifier which identifies the conversation. The message can also identify the result of its processing, such as “Success,” “Failed,” “NoService,” “IncompleteAnswers,” or “IncorrectAnswers.” The message can also include the identifier assigned to the customer (e.g., CustomerId) by the utility entity 102. The message can also indicate the type of service for which the customer is being registered, such as “Electric” or “Gas.” The message can also provide a service point identifier (e.g., ServicePointNumber) associated the service point (e.g., metering mechanism) associated with the service.

The message can also indicate whether files for this customer are currently available to be downloaded by the facilitator 116. If so, the message can provide information that can be used by the facilitator 116 to download these files, as will be discussed in greater detail below in connection with FIG. 9.

In the event that the RegisterCustomer message indicates that the utility entity 102 failed to properly register the customer, the facilitator 116 can interact with the customer in attempt to remedy the problem.

FIG. 8 shows a conversation whereby the facilitator 116 can remove an existing registration of a customer, or in other words, unregister a customer. To perform this function, the facilitator 116 can call the Execute web service method of the utility entity 102 and pass in an UnregisterCustomer message.

In one representative and non-limiting case, the UnRegisterCustomer message includes an identifier (e.g., PartnerId) which identifies the utility entity 102 and a ticket identifier which identifies the conversation. The message can also include the identifier (e.g., CustomerId) which identifies the customer that is being unregistered. The message can also identify the type of service for which the customer is to be unregistered, such as “Electric” or “Gas.” The message can also identify the reason why the customer is being unregistered, such as “Unknown,” “CustomerRequest,” (because the customer has expressly requested this action), or “ApplicationRequest” (because the facilitator 116 has independently requested this action).

In response to this message, the utility entity 102 determines whether the customer identifier specified by the facilitator 116 exists in its system. If so, the utility entity 102 removes the customer identifier from its file delivery list, which will cause it to cease sending the customer's resource-related information to the facilitator 116.

Upon completing the above operations, the utility entity 102 calls the facilitator's 116 Update web service method, passing a CustomerUnregistered message as input. The CustomerUnregistered message informs the facilitator 116 of the outcome of its processing of the UnregisterCustomer message. According to one illustrative and non-limiting case, the CustomerUnregistered message can include an attribute which identifies the utility entity (e.g., PartnerId) and a ticket identifier which identifies the conversation. The message can also identify the result of its processing, e.g., indicating whether or not it successfully removed the identified customer from its file delivery list. If the operation was a success, the facilitator 116 will also no longer expect to receive usage data for this customer in subsequent file deliveries.

Although not shown in FIG. 8, the utility entity 102 can also initiate an unregister-type operation. To do so, the utility entity 102 calls the Execute web service method of the facilitator 116, passing an UnregisterCustomer message as input.

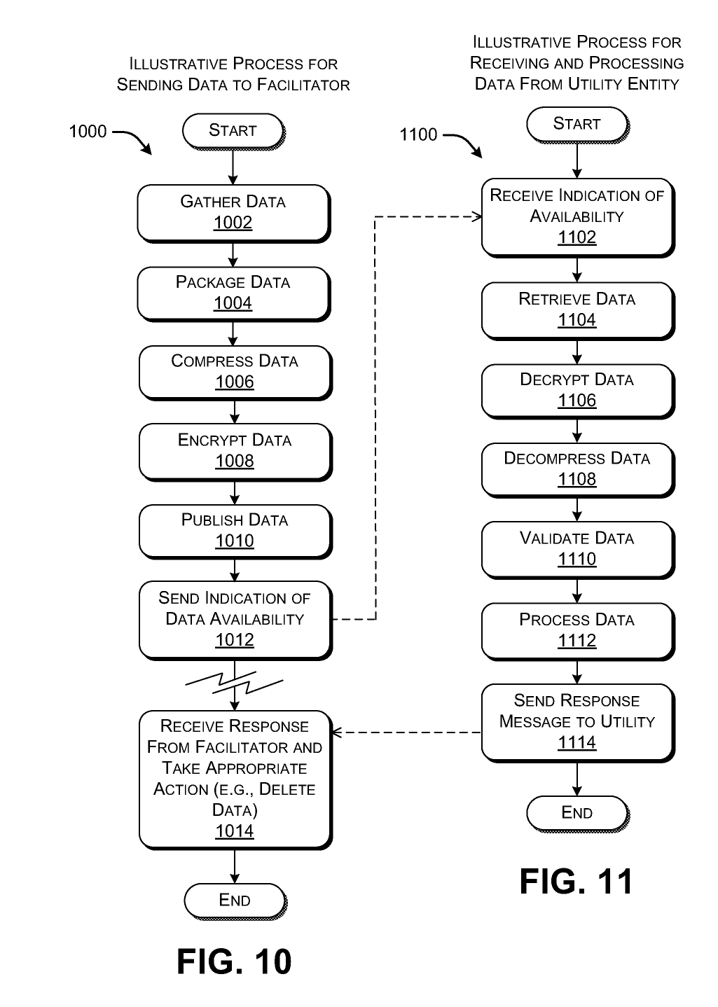

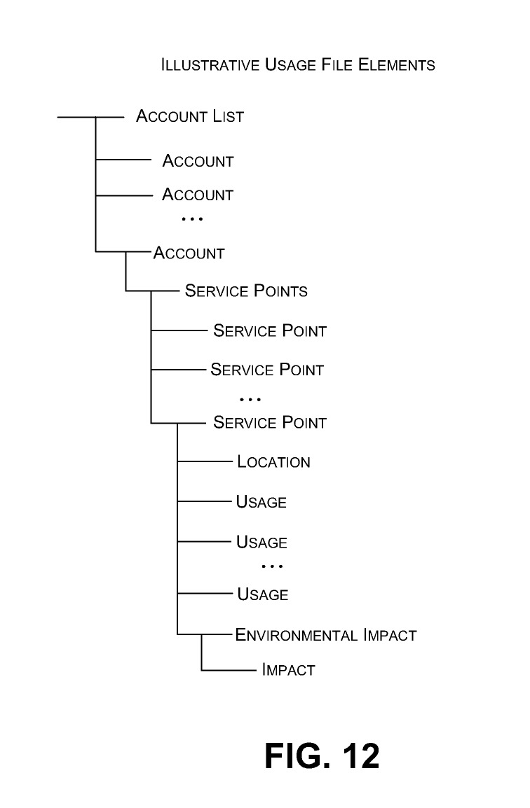

FIG. 9 shows one illustrative conversation that can be used to pass files from the utility entity 102 to the facilitator 116. FIGS. 10 and 11, described below, provide more encompassing information regarding the process for transferring resource-related information from the utility entity 102 to the facilitator 116.

The utility entity 102 initiates the process of transferring files by calling the facilitator entity's 116 Execute method, passing a FilesAvailable message 902 as input. According to one illustrative and non-limiting implementation, the FilesAvailable message 902 includes the identifier (e.g., PartnerID) associated with the utility entity 102. The FilesAvailabile message 902 also include file information that describes one or more files that are available for downloading. The file information for a file, in turn, can include a collection of properties. For example, the file information can include a property which identifies the location of a schema that the facilitator 116 can use to validate the file. The file information can also include a secure address from which the facilitator 116 can download the file. In one example, the address corresponds to a Uniform Resource Locator (URL) address of the file. The file information can also include an identifier chosen by the utility entity 102 to represent the file. The file information can also provide key information and the like that can be used by the facilitator 116 to decrypt the file (to be described in greater detail below with reference to FIGS. 10 and 11). The file information can also include information which identifies the algorithm that has been used to encrypt the file, such as, in one example, Rijndael. The above-described information is provided for each file identified in the message 902.

The facilitator 116 responds to the FilesAvailable message by downloading the identified file(s) from the identified secure location. After downloading the files, the facilitator 116 calls the Update web service method of the utility entity 102, passing in a DownloadedFiles message containing information about the files downloaded and their status.

In one representative and non-limiting example, the DownloadedFiles message can include the identifier (e.g., PartnerId) which identifies the utility entity 102 and a ticket identifier which identifies the conversation. The DownloadedFiles message can also identify the status of the downloading operation performed by the facilitator 116. In one example, this component of the message can take on the values of “OK” (meaning that the downloading operation succeeded), “Corrupt” (meaning the files were found to be corrupt), or “Failed” (meaning that the downloading operation failed for any other reason). The message can also identify the address of each file that that was successfully or unsuccessfully downloaded. The message can also provide the identifier assigned to each file and/or any descriptive message pertaining to the downloading operation.

The utility entity 102 can also initiate the transfer of files as part of its response to the RegisterCustomer conversation described above. That is, assume that the utility entity 102 has files available at the same time that it is processing a customer's registration request. If so, the utility entity 102 can initiate a file delivery conversation with the facilitator 116 by specifying information about the available files in the CustomerRegistered message. The files can be identified within this message in the same manner described above with respect to the FilesAvailable message.

FIGS. 10 and 11 describe procedures (1000, 1100) for preparing resource-related information and for supplying the resource-related information to the facilitator 116. Namely, FIG. 10 describes the process from the perspective of the utility entity 102, while FIG. 11 describes the process from the perspective of the facilitator 116. FIGS. 10 and 11 complement the description provided above for FIG. 9 by more fully describing the encompassing context in which the FilesAvailable conversation can be conducted.

Starting with FIG. 10, in block 1002, the utility entity 102 collects resource-related information from the service points for one or more customers. As described above, the utility entity 102 can collect this information in various ways, e.g., via a network-implemented communication path or via a manual collection procedure. In an automated approach, the service points can supply the resource-related information using a push technique (in which the service points independently forward the information, e.g., at fixed intervals) and/or a pull technique (in which the utility entity 102 polls the service points to collect the information). Also, in block 1002, the utility entity 102 can store the resource-related information in the store 132.

In block 1004, the utility entity 102 packages the resource-related information that is received, together with other resource-related information, into one or more files, as governed by respective schemas. This produces standardized resource-related information. In one example, the utility entity 102 can forward any one or more of three types of files. A resource usage file provides information regarding the consumption of resources by one or more customers. An invoice file provides invoice information associated with the consumption of resources by one or more customers (e.g., in which the customers are billed for their consumption of resources). A rate file provides rate information regarding the basis for charging the customers for their consumption of resources. Section C provides detailed information regarding one format for creating the three files summarized above.

In block 1006, the utility entity 102 compresses the files using any compression technique, such as the publically available gzip technique.

In block 1008, the utility entity 102 encrypts the files using any encryption technique. More specifically, the utility entity 102 can encrypt the files using a certificate (obtained from a trusted source of certificates) which it has uploaded to the facilitator 116 in advance. The utility entity 102 can use any algorithm to encrypt the files. As part of the encryption process, the utility entity 102 can save key information associated with the algorithm used to encrypt the files. For example, for certain encryption algorithms, the utility entity 102 can save a key and initialization vector for subsequent use.

In block 1010, the utility entity can publish the encrypted files to a location that is accessible to the facilitator 116. In one example, without limitation, the utility entity can publish the files at an HTTPS secured internet-facing server location (URL).

In block 1012, the utility entity 102 sends the FilesAvailable message to the facilitator 116, which is an electrical digital data message. In one illustrative case, in forming this message, the utility entity 102 can prepare information that communicates the key and initialization vector, which enables the facilitator 116 to decrypt the resource-related information. The utility entity 102 can then encrypt the assembled byte array using the public key of the facilitator 116. This resultant encrypted information constitutes the key information provided in the FilesAvailable message described in the context of FIG. 9.

In block 1014, the utility entity 102 receives a DownloadedFiles message from the facilitator 116 which indicates whether the facilitator 116 has successfully downloaded the files. In the event that the facilitator has successfully downloaded the files, the utility entity 102 can delete the files from the secure location.

The break in operations between block 1012 and block 1014 shown in FIG. 10 indicates that the coupling between these two operations is asynchronous, meaning that there is no set timeframe in which block 1014 is performed following block 1012.

Now advancing to FIG. 11, in block 1102, the facilitator 116 receives the FilesAvailable message from the utility entity 102.

In block 1104, the facilitator 116 retrieves the files from the location identified in the FilesAvailable message. In block 1104, the facilitator 116 can also store the files in the store 136.

In block 1106, the facilitator 116 decrypts the files using the encryption information provided in the FilesAvailable message.

In block 1108, the facilitator 116 decompresses the files based on the compression technique that is identified in the FilesAvailable message.

In block 1110, the facilitator 116 validates the resource-related information in the files using the schema identified in the FilesAvailable message.

In block 1112, upon successfully decrypting, decompressing, and validating the files, the facilitator 116 processes the resource-related information in the files in any manner. For example, the facilitator 116 can store the resource-related information in its store 136 so that it can be accessed by authorized customers.

In block 1114, the facilitator 116 sends the DownloadedFiles message to the utility entity 102 which indicates the status of the operations described in FIG. 11. That is, the DownloadedFiles message indicates whether the facilitator 116 was successful in downloading and processing the files provided by the utility entity 102.

Other approaches can be used to transfer files to the facilitator 116 besides the technique illustrated in connection with FIGS. 9-11. For example, in the above approach, the utility entity 102 notifies the facilitator 116 of the existence of files to be downloaded. Alternatively, or in addition, the facilitator 116 can use a polling approach to independently request the files from the utility entity 102 without first receiving a message from the utility entity 102. Alternatively, or in addition, the utility entity 102 can independently send the files to the facilitator 116 without first sending a message to the facilitator 116, and so on. Moreover, the utility entity 102 can send the files to the facilitator 116 in various alternative ways, such as by breaking the files into parts and sending the files in piecemeal fashion, and so on.

### C. Illustrative Files for Providing Resource-Related Information

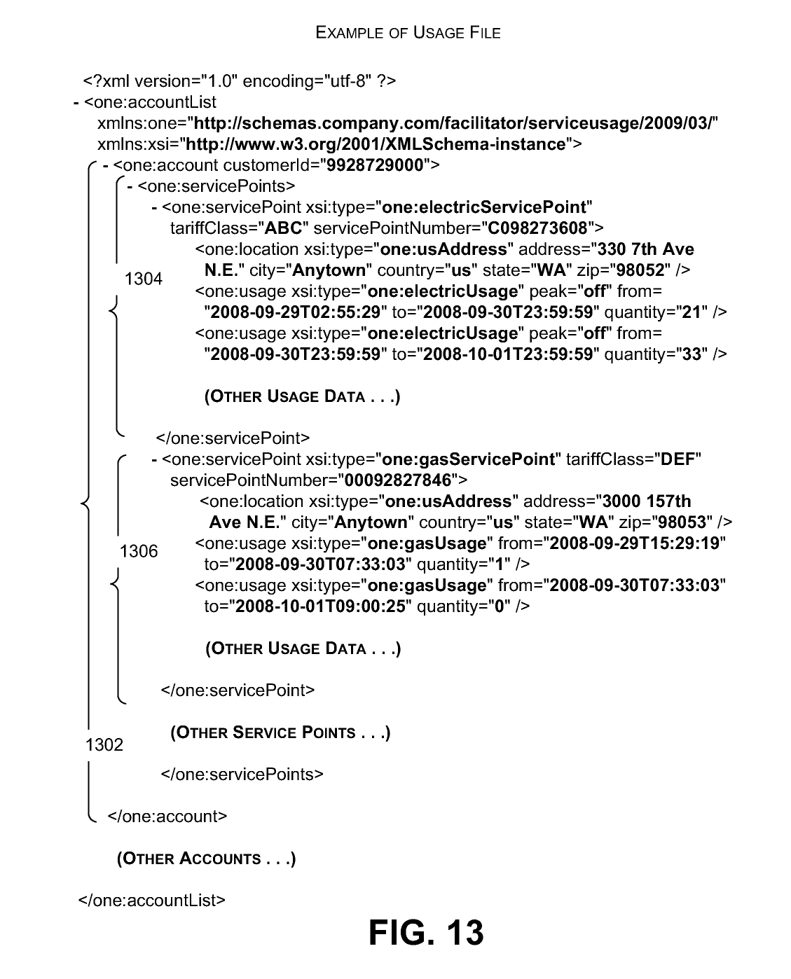

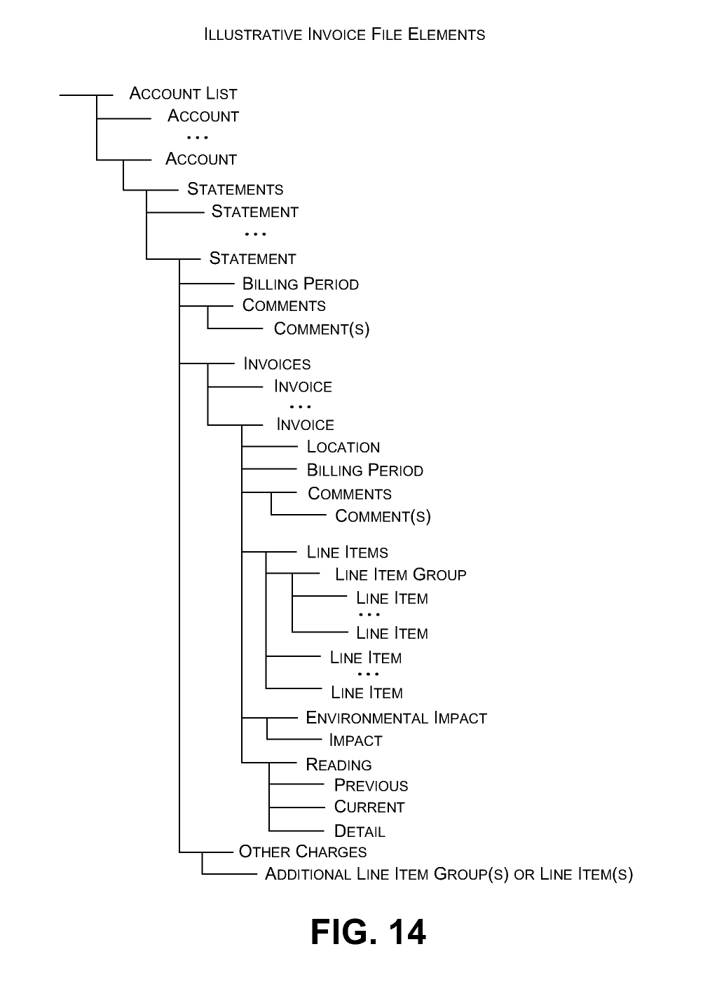

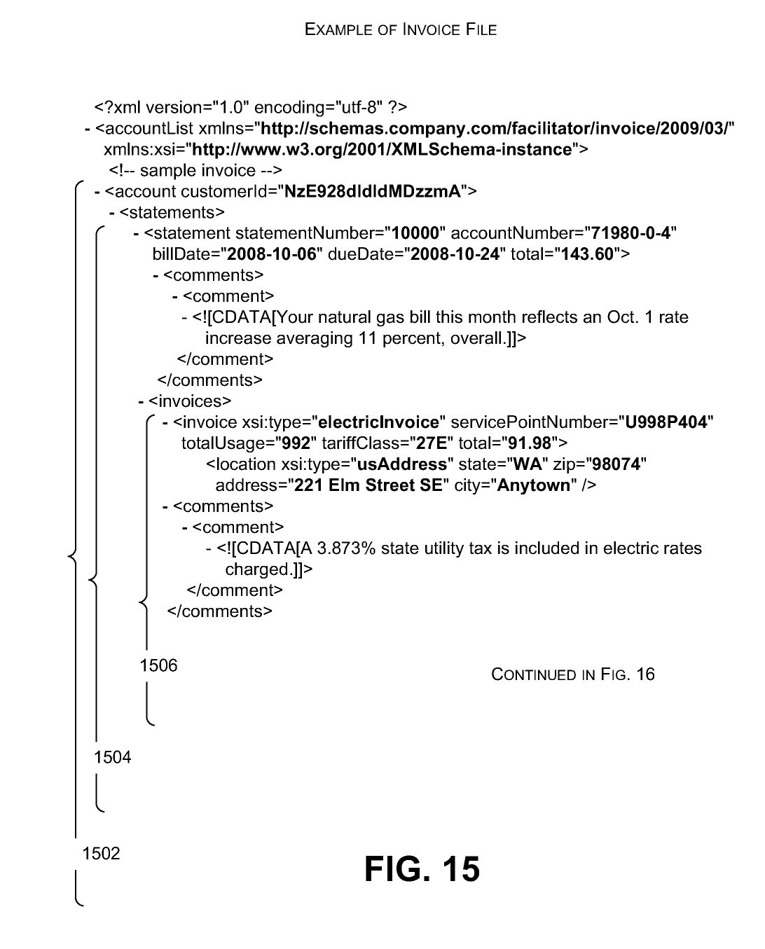

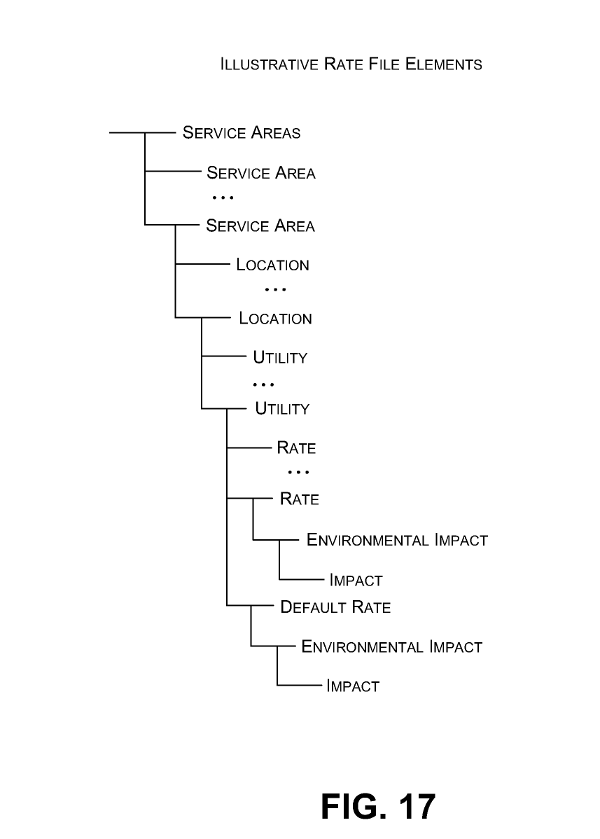

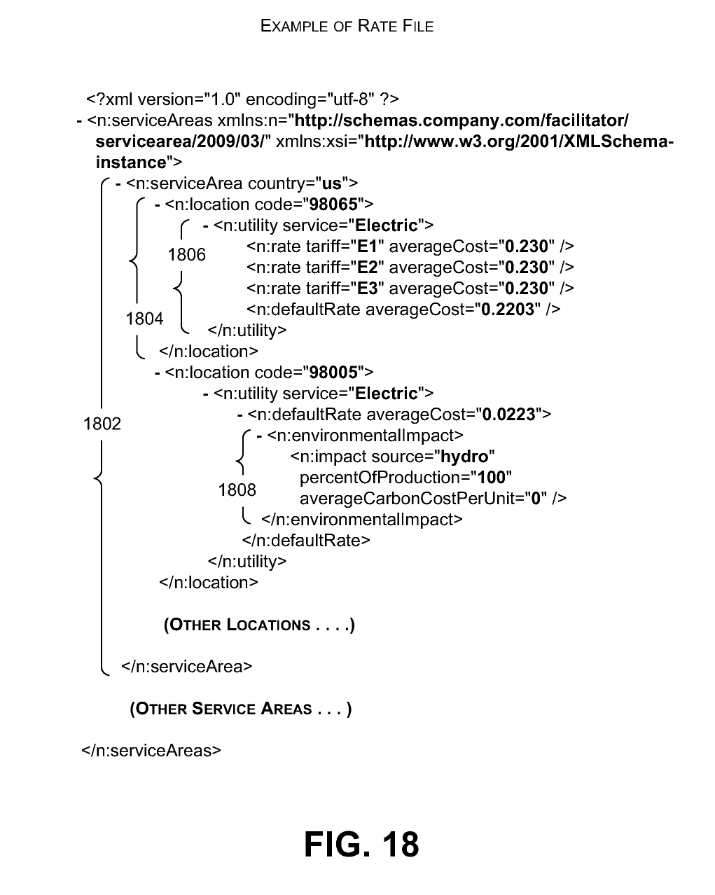

FIGS. 12-18 show examples of a format that can be used to express the resource related information. As summarized above, in one example, the utility entity 102 can package the resource-related information into three types of files: a resource usage file; an invoice file; and a rate file. FIGS. 12-13 provide information regarding the illustrative characteristics of the resource usage file. FIGS. 14-16 provide information regarding the illustrative characteristics of the invoice file. And FIGS. 17-18 provide information regarding the illustrative characteristics of the rate file.

By way of overview, each file expresses resource-related items in a data structure, as governed by a schema. The schema defines the types of resource-related items that can be included in a particular file. Each type of resource-related item is defined by a particular element. The schema also identifies the accepted attributes associated with the elements, as well as the accepted values associated with the attributes. The schema also defines the ways in which resource-related items can be organized within the file. More specifically, as will be described, the schema defines a hierarchical arrangement of resource-related items within the file. In summary, the schema identifies the format of individual resource-related items within a file as well as the data structure of the file as a whole, where the term “format” encompasses any characteristic of the resource-related items and/or the data structure as a whole.

A file can include any number of resource-related items that are defined by a particular element of the schema. For example, a schema may define a usage element; a particular file that is constructed based on this schema can include one or more usage items that are defined by the usage element. FIGS. 12, 14, and 17 demonstrate this characteristic by repeating certain types of resource-related items, such as, in FIG. 12, including multiple usage items. However, these figures present examples that do not provide an exhaustive demonstration of the ways in which resource-related items can be duplicated within a particular file.

Moreover, a file can omit one or more of the elements identified in the schema. And any resource-related item can omit one or more of its permitted attributes. As such, certain elements and attributes can be considered optional. In other cases, certain parts of the resource-related information may be dependent on other parts of the resource-related information in any manner. For example, the schema can specify that certain attributes and/or values are constrained by the inclusion or omission of other attributes and/or values.

In the examples described below, the resource-related information in the files is expressed using the extensible markup language (XML). However, other languages can be used to express the resource-related information.

Starting with FIG. 12, this figure shows an overview of resource-related items that can be used within a resource usage file according to one illustrative implementation. Overall, the resource usage file provides information regarding the consumption of resources by one or more customers.

An <accountList> element is a root element that contains a collection of <account> elements.

An <account> element is a child element of the <accountList> element. This element defines a customer account. The <account> element can include a customerId attribute; the customerID is a customer identifier sent to the facilitator 116 during the customer registration process.

A <servicePoints> element is a child element of the <account> element. It contains a collection of <servicePoint> elements.

A <servicePoint> element is a child element of the <servicePoints> element that corresponds to a service point (e.g., associated with a metering mechanism). This element includes a <location> sub-element (to be described) and one or more <usage> sub-elements (to be described). This element also contains an <environmentalImpact> sub-element (to be described) for certain types of services, such as electric service points. The servicePoint element can include a type attribute which identifies the type of service associated with the service point, such as “electricServicePoint” or “gasServicePoint.” This element may also include a tariffClass attribute that identifies a tariff class associated with the service point. This element may also identify a servicePointNumber attribute which identifies a service point number associated with the service point.

A <location> element is a child element of the <servicePoint> element. This element specifies the address of a service point. This element can have a type attribute that identifies the type of the address, e.g., “usAddress” or “caAddress.” This element can also include an address attribute, a city attribute, a state attribute, a zip attribute, a province attribute, and a postalCode attribute, etc. These attributes specify different parts of the address of the location, accommodating the address conventions of particular countries.

A <usage> element is a child element of the <servicePoint> element. This element specifies the energy usage of the parent service point. This element can have a type attribute which identifies the type of service associated with the usage, such as “electricUsage” or “gasUsage.” This element also have a “from” attribute and a “to” attribute which identify, respectively, the starting date and ending date of the usage period. This element also includes a quantity attribute which identifies the quantity of energy used within the usage period. This element can also include a peak attribute (in the case of an electric service) which indicates whether the usage period is considered a peak period; in one example, possible values include “on,” “off,” and “shoulder.” The <usage> element can also include a source attribute which identifies the source of the energy associated with the <usage> element; in one example, the possible values include “nuclear,” “coal,” “gas,” “hydro,” “wind,” “solar,” “geo,” “other,” or “unknown.”

An <environmentalImpact> element is a child element of the <servicePoint> element. This element wraps environmental impact information.

An <impact> element is a child element of the <environmentalImpact> element. This element contains environmental impact information. It can include a percentOfProduction attribute that identifies a percentage of a total energy production associated with the parent <servicePoint> element (where usage associated the <servicePoint> element is a fraction of some identified total energy production). The <environmentalImpact> element also can include an averageCarbonCostPerUnit attribute which identifies the approximate tons of carbon dioxide released into the environment per unit associated with the parent <servicePoint> element. This element can also include a source attribute that identifies the source of energy associated with the parent <servicePoint> element; in one example, this attribute can take on one of the values “nuclear,” “coal,” “gas,” “hydro,” “wind,” “solar,” “geo,” “other,” or “unknown.”

FIG. 13 shows an abbreviated example of a particular usage file, which is formed in accordance with the usage schema. As shown there, the usage file includes resource-related information 1302 pertaining to one particular customer account. The usage file also includes resource-related information (1304, 1306) regarding two service points, such as an electrical service point and a gas service point.

FIG. 14 shows an overview of resource-related items that can be used within an invoice file according to one illustrative implementation. Overall, an invoice file provides information regarding invoices provided to customers based on their consumption of resources.

An <accountList> is a root element of the schema. This element contains a collection of <account> elements.

An <account> element is a child element of the <accountList> element. The <account> element defines a customer account. This element can include a customerId attribute assigned by the facilitator 116 during the registration process, which identifies the customer.

A <statements> element is a child element of the <account> element. This element contains a collection of <statement> elements.

A <statement> element is a child element of the <statements> element. This element defines a statement. The <statement> element can include a billDate attribute which identifies the date the bill was issued. The element can also include an accountNumber attribute which identifies an applicable utility service account number. The element can also include a total attribute which identifies the total amount of the bill. The element can also include a dueDate element which identifies the due date of the bill. The element can also include a statementNumber attribute which provides an identifier associated with the statement.

A <billingPeriod> element is a child element of the <statement> element that specifies the billing period associated with a statement. This element can include a start attribute and an end attribute which identify, respectively, the starting and ending dates of the billing period.

A <comments> element is a child element of the <statement> element. This element contains a collection of <comment> elements.

A <comment> element is a child element of the <comments> element and provides a text comment, such as “Your charges this month were 12% lower than the same month last year.”

An <invoices> element is a child element of the <statement> element and contains a collection of <invoice> elements.

An <invoice> element is a child element of the <invoices> element and defines an invoice. It can include a type attribute which describes the type of service associated with the invoice, such as “electricInvoice” or “gasInvoice.” A tariffClass element identifies the tariff class associated with the invoice. A serviceType attribute identifies the type of service associated with the invoice, such as “gas,” “electric,” “fuelOil,” or “lp.” An invoiceNumber attribute provides an invoice identifier assigned to the invoice. An optional servicePointNumber provides a service point identifier associated with the invoice. A total attribute identifies the total charge for this invoice.

A <location> element is a child element of the <invoice> element. This element specifies the address of a service point. This element can have a type identifier that identifies the type of the address, e.g., “usAddress” or “caAddress.” This element can also include an address attribute, a city attribute, a state attribute, a zip attribute, a province attribute, and a postalCode attribute, etc. These attributes specify different parts of the address of the location, accommodating the conventions of particular countries.

Another <billingPeriod> element is a child element of the <invoice> element that specifies the billing period associated with a statement. This element can include a start attribute and an end attribute which identify, respectively, the starting and ending dates of the billing period.

Another <comments> element may depend on the <invoice> element as a child thereof. This element contains a collection of <comment> elements.

Another <comment> element is a child element of the <comments> element and contains a text comment, such as “Your charges this month were 12% lower than the same month last year.”

A <lineItems> element is a child element of the <invoice> element and contains a collection of <lineItem> elements, <lineItemGroup> elements, or both types of elements.

A <lineItemGroup> element is a child element of the <lineItems> element. This element contains a collection of <lineItem> elements. This element can include a label attribute that provide a human-readable label for this line item group, such as “Delivery Charges.” A total attribute identifies the total amount associated with a line item group.

A <lineItem> element is a child element of either the <lineItems> element or the <lineItemGroup> element. This element defines a line item in the invoice. In other words, this element provides a piece of descriptive information associated with the invoice. The element can include a type attribute which categorizes the line element, taking on values such as “charge,” “tax,” “fee,” “credit,” or “adjustment.” A percentage attribute describes percentage information associated with the line item. A rate attribute provides rate information associated with the line item. A quantity attribute provides quantity information associated with the line item. A label attribute provides a human-readable label for the line item, such as “Delivery Charge.” A “from” attribute and “to” attribute identify, respectively, a starting date and an ending date associated with the line item. A total attribute describes a total amount associated with the line item. A chargeType attribute describes the type of charge associated with the line item, such as “generation,” “distribution,” “baseRate,” “energy,” or “other.” A jurisdiction attribute identifies the jurisdiction associated with the line item, such as “city,” “county,” “state,” “federal,” or “other.”

An <environmentalImpact> element is a child element of the <invoice> element and wraps the environmental impact information.

An <impact> element is a child element of the <environmentalImpact> element. This element contains environmental impact information. It can include a percentOfProduction attribute that identifies a percentage of a total energy production associated with the parent <invoice> element. The <environmentalImpact> element also can include an averageCarbonCostPerUnit attribute which identifies the approximate tons of carbon dioxide released into the environment per unit associated with the parent <invoice> element. This element can also include a source attribute that identifies the source of energy associated with the parent <invoice> element; in one example, this attribute can take on one of the values “nuclear,” “coal,” “gas,” “hydro,” “wind,” “solar,” “geo,” “other,” or “unknown.”

A <reading> element is a child of the <invoice> and contains meter reading information associated with the parent <invoice> element. This element can include an “estimated” attribute which indicates whether or not the reading represents an estimated reading.

A <previous> element is a child element of the <reading> element that contains the previous meter reading information. This element can include a date attribute that provides the date of the previous reading and a quantity attribute that identifies the value of the previous reading.

A <current> element is a child of the <reading> element that contains the current meter reading information associated with the invoice. This element can include a date attribute that provides the date of the current reading and a quantity attribute that identifies the value of the current reading.

A <detail> element is a child element of the <reading> element that details the meter reading information. This element can include a multiplier attribute that identifies a multiplier value associated with an invoice (e.g., in one case, indicating a power of ten that a meter uses in reporting). A <difference> attribute provide difference information associated with an electric invoice. A kwh attribute provide kilowatt information for an electric invoice. A ccf attribute provides ccf (hundred cubic feet) information for a gas invoice. A factor attribute provides factor information for a gas invoice, e.g., indicating how the ccf value is converted into a heating unit for billing purposes. A therms attribute provides therm information for a gas invoice.

An <otherCharges> element is a child of the <statement> element that contains a collection of <lineItem> elements, <lineItemGroup> elements, or both. The <otherCharges> element represents miscellaneous charges not included in the invoice.

Another <lineItemGroup> element is a child element of the <otherCharges> element that contains a collection of <lineItem> elements. It may include the same attributes described above for the previously-described <lineItemGroup> element.

Another <lineItem> element is a child element of the either the <otherCharges> element or the <lineItemGroup> element. This element provides descriptive information associated with a line item and can include any of the attributes described above for the previously-described <lineItem> element.

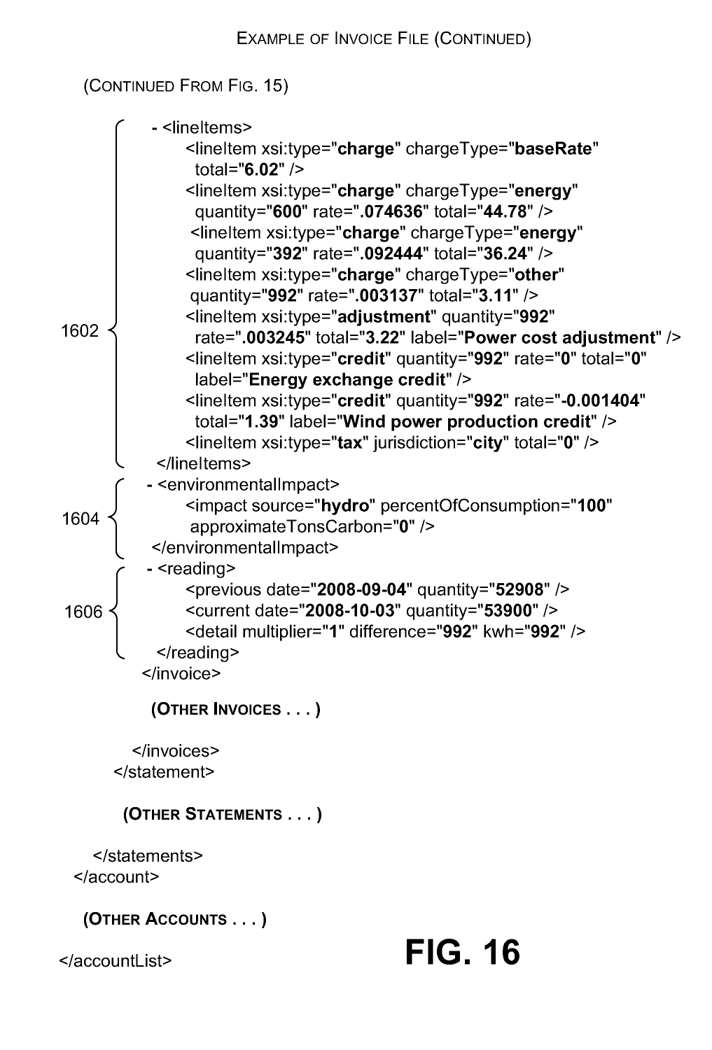

FIGS. 15 and 16 show an abbreviated example of a particular invoice file, which is formed in accordance with the invoice schema. As shown there, the invoice file includes resource-related information 1502 pertaining to one particular customer account. The invoice file also includes resource-related information 1504 pertaining to a particular statement. The invoice file also includes resource-related information 1506 associated with a particular invoice. The invoice file also includes resource-related information 1602 pertaining to a particular collection of line items. The invoice file also includes resource-related information 1604 pertaining to environmental impact information. The invoice file also includes resource-related information 1606 pertaining to reading information, and so on.

FIG. 17 shows an overview of resource-related items that can be used within a rate file according to one illustrative implementation. Overall, the rate file provides information regarding the rates that are applicable to the consumption of resources by one or more customers.

A <serviceAreas> element is a root element of the file that that contains a collection of <serviceArea> elements.

A <serviceArea> element is a child element of the <serviceArea> element. This element defines a service area in which resources are provided. It can include a country attribute that identifies the country, such as “us” for the United Stated, or “ca” for Canada.

A <location> element is a child element of the <serviceArea> element that defines a location and contains a collection of <utility> elements. This element includes a code attribute that identifies a code assigned to the location.

A <utility> element is a child element of the <location> element that defines a utility and contains a collection of <rate> elements and a single <defaultRate> element. This element can include a service attribute that identifies the type of service associated with the utility, such as “Electric” or “Gas.”

A <rate> element is a child element of the <utility> element and defines the rate. This element can include a tariff attribute that provides tariff information and an averageCost element that defines average cost information associated with this rate.

An <environmentalImpact> element is a child element of the <rate> element that wraps the environmental impact information.

An <impact> element is a child of the <environmentalImpact> element that contains the environmental impact information. It can include a percentOfProduction attribute that identifies a percentage of a total energy production associated with the parent <rate> element. The <environmentalImpact> element also can include an averageCarbonCostPerUnit attribute which identifies the approximate tons of carbon dioxide released into the environment per unit associated with the parent <rate> element. This element can also include a source attribute that identifies the source of energy associated with the parent <rate> element; in one example, this attribute can take on one of the values “nuclear,” “coal,” “gas,” “hydro,” “wind,” “solar,” “geo,” “other,” or “unknown.”

A <defaultRate> element is a child element of the <utility> element and contains default rate information. This element may include an averageCost attribute that provides the average cost for the default rate.

Another <environmentalImpact> element can depend on the <defaultRate> element as a child element thereof. This element wraps the environmental impact information.

Another <impact> element is a child of the <environmentalImpact> information and contains environmental impact information. This element can include the attributes described above for the first-mentioned <impact> element.

FIG. 18 shows show an abbreviated example of a particular rate file, which is formed in accordance with the rate schema. As shown there, the rate file includes resource-related information 1802 pertaining to one particular service area, the United States. The rate file also includes resource-related information 1804 pertaining to one particular location within the service area. The rate file also includes resource-related information 1806 pertaining to one particular utility within the location. The rate file also includes resource-related information 1808 pertaining to environmental impact information.

### D. Representative Processing Functionality

FIG. 19 sets forth illustrative electrical data processing functionality 1900 that can be used to implement any aspect of the functions described above. With reference to FIGS. 1 and 2, for instance, the type of processing functionality 1900 shown in FIG. 19 can be used to implement any aspect of the computer system provided by the utility entity 102, any aspect of the computer system provided by the facilitator 116, any aspect of the customer processing functionality (CPF) 122, and so on. In one case, the processing functionality 1900 may correspond to any type of computing device that includes one or more processing devices.

The processing functionality 1900 can include volatile and non-volatile memory, such as RAM 1902 and ROM 1904, as well as one or more processing devices 1906. The processing functionality 1900 also optionally includes various media devices 1908, such as a hard disk module, an optical disk module, and so forth. The processing functionality 1900 can perform various operations identified above when the processing device(s) 1906 executes instructions that are maintained by memory (e.g., RAM 1902, ROM 1904, or elsewhere). More generally, instructions and other information (such as the above-described files) can be stored on any computer readable medium 1910, including, but not limited to, static memory storage devices, magnetic storage devices, optical storage devices, and so on. The term computer readable medium also encompasses plural storage devices. The term computer readable medium also encompasses signals transmitted from a first location to a second location, e.g., via wire, cable, wireless transmission, etc.

The processing functionality 1900 also includes an input/output module 1912 for receiving various inputs from a user (via input modules 1914), and for providing various outputs to the user (via output modules). One particular output mechanism may include a presentation module 1916 and an associated graphical user interface (GUI) 1918. The processing functionality 1900 can also include one or more network interfaces 1920 for exchanging data with other devices via one or more communication conduits 1922. One or more communication buses 1924 communicatively couple the above-described components together.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. An electrical computer system for providing resource-related information to a resource management facilitator system, comprising:
a logic component configured to receive the resource-related information from a plurality of service points associated with a plurality of resource consumers and store the resource-related information in at least one store, the resource-related information corresponding to electrical digital data that pertains to consumption of at least one physical resource by the plurality of resource consumers;
a logic component configured to package the resource-related information that is received from the plurality of service points, together with other resource-related information, into at least one file, said at least one file providing resource-related information using a plurality of resource-related items expressed in a data structure; and
a logic component configured to provide said at least one file to the resource management facilitator system via a coupling mechanism,
at least one schema defining an accepted format of the resource-related items and the data structure,
said at least one schema providing a standardized format for use by different utility entities to express resource-related information.

2. The computer system of claim 1, wherein the computer system is associated with a utility entity which provides at least one physical resource to the resource consumers.

3. The computer system of claim 1, wherein said at least one file comprises a plurality of files, and wherein said at least one schema comprises a plurality of schemas for defining an accepted format of resource-related items and data structures within the plurality of respective files.

4. The computer system of claim 3, wherein the plurality of files includes:
a resource usage file governed by a resource consumption schema;
an invoice file governed by an invoice schema; and
a rate file governed by a rate schema.

5. The computer system of claim 1, further comprising:
a logic component configured to compress said at least one file to produce a compressed file; and
a logic component configured to encrypt the compressed file to produce an encrypted file.

6. The computer system of claim 1, further comprising:
a logic component configured to publish said at least one file to a location that is accessible to the resource management facilitator system; and
a logic component configured to send an electrical digital data message to the resource management facilitator system which indicates that said at least one file is available for downloading.

7. The computer system of claim 6, wherein the message includes:
information regarding the location at which said at least one file is accessible to the resource management facilitator system; and
information regarding security provisions taken with respect to said at least one file.

8. A method implemented using a computer system for receiving resource-related information from another system, comprising:
receiving an electrical digital data message from the other system via a coupling mechanism, the electrical digital data message indicating that at least one file is available, said at least one file expressing resource-related information using a plurality of resource-related items;
retrieving said at least one file from the other system via the coupling mechanism based on the electrical digital data message; and
storing said at least one file in at least one store,
said at least one file providing a standardized format for use by different utility entities to express resource-related information,
said at least one file comprising one or more of:
a resource usage file governed by a resource consumption schema, the resource consumption schema defining an acceptable format of resource-related items in the resource usage file and a data structure used to express the resource-related items in the resource usage file;
an invoice file governed by an invoice schema, the invoice schema defining an acceptable format of resource-related items in the invoice file and a data structure used to express the resource-related items in the invoice file; or
a rate file governed by a rate schema, the rate schema defining an acceptable format of resource-related items in the rate file and a data structure used to express the resource-related items in the rate file.

9. The method of claim 8, wherein the other system is associated with a utility entity which provides at least one resource to a plurality of resource consumers.

10. The method of claim 8, wherein the computer system is associated with a resource management facilitator system which receives resource information from a plurality of other systems associated with a plurality of respective utility entities.

11. The method of claim 8, further comprising decrypting said at least one file based on key information provided in the electrical digital data message.

12. The method of claim 8, further comprising sending a response to the other system which indicates a result of said retrieving.

13. A computer readable storage medium for storing resource-related information for access and processing by electrical data processing functionality, comprising:
at least one file which expresses resource-related information using a plurality of resource-related items in a data structure, at least one schema defining an accepted format of the resource-related items and the data structure,
the data structure providing a hierarchical relation of resource-related items within said at least one file, as defined by said at least one schema,
said at least one schema providing a standardized format for use by different utility entities to express the resource-related information, at least one resource-related item representing consumption of at least one physical resource by at least one consumer within a resource-receiving unit.

14. The computer readable storage medium of claim 13, wherein said at least one file comprises a plurality of files, and wherein said at least one schema comprises a plurality of schemas for defining an accepted format of resource-related items and data structures within the plurality of respective files.

15. The computer readable storage medium of claim 14, wherein the plurality of files includes a resource usage file governed by a resource consumption schema.

16. The computer readable storage medium of claim 15, wherein the resource usage file includes at least:
an account element for expressing one or more resource-related items pertaining to one or more customer accounts;
a service point element for expressing one or more resource-related items pertaining to one or more monitoring mechanisms associated with a particular customer account; and
a usage element for expressing one or more resource-related items pertaining to one or more resource usages associated with a particular monitoring mechanism.

17. The computer readable storage medium of claim 14, wherein the plurality of files includes an invoice file governed by an invoice schema.

18. The computer readable storage medium of claim 17, wherein the invoice file includes at least:
an account element for expressing one or more resource-related items pertaining to one or more customer accounts;
a statement element for expressing one or more resource-related items pertaining to one or more invoice statements associated with a particular customer account;
an invoice element for expressing one or more resource-related items pertaining to one or more invoices associated with a particular invoice statement; and
a line item element for expressing one or more resource-related items pertaining to one or more lines of information associated with a particular invoice.

19. The computer readable storage medium of claim 14, wherein the plurality of files includes a rate file governed by a rate schema.

20. The computer readable storage medium of claim 19, wherein the rate file includes at least:
a service area element for expressing one or more resource-related items pertaining to one or more areas in which resources are provided;
a location element for expressing one or more resource-related items pertaining to one or more locations associated with a particular service area;
a utility element for expressing one or more resource-related items pertaining to one or more utilities that operate within a particular location; and
a rate element for expressing one or more resource-related items pertaining to one or more rates associated with a particular utility.
